(19) United States
(12) Patent Application Publication
(10) Pub. No.: US 2020/0052533 A1
(43) Pub. Date: Feb. 13, 2020

(54) ROTATING ELECTRICAL MACHINE WITH A VARIABLE STATOR NOTCH WIDTH

(71) Applicant: Valeo Equipements Electriques Moteur, Creteil (FR)

(72) Inventors: Radu Fratila, Creteil Cedex (FR); Jérome Legranger, Creteil Cedex (FR)

(73) Assignee: Valeo Equipements Electriques Moteur, Creteil (FR)

(21) Appl. No.: 16/604,003

(22) PCT Filed: Apr. 19, 2018
(86) PCT No.: PCT/EP2018/059985

§ 371 Date: Oct. 9, 2019

(30) Foreign Application Priority Data
Apr. 20, 2017 (FR) 1753451

(51) Int. Cl. H02K 1/16

(52) U.S. Cl. CPC H02K 1/165

(57) ABSTRACT

The invention relates mainly to a rotating electrical machine (10) for a motor vehicle, comprising:—a rotor;—a stator (11) extending along an axis, said stator (11) comprising a body (24) provided with a plurality of stator teeth (28) defining slots (30, 30′),—the stator (11) comprising a winding with conductors (35) housed in the slots (30, 30′);—in a plane (P) orthogonal to the axis along which the stator (11) extends,—a first slot (30) has a first width (L1) measured in an orthoradial direction, radially in the middle of the first slot (30), and—a second slot (30′), separate from the first slot (30), has a second width (L2) measured along an orthoradial direction, radially in the middle of the second slot (30′); characterised in that the first slot width (L1) is different from the second slot width (L2).

The present invention relates to a rotary electrical machine with a variable stator notch width.

In a known manner, rotary electrical machines comprise a stator and a rotor integral with a shaft. The rotor can be integral with a driving and/or driven shaft, and can belong to a rotary electrical machine in the form of an alternator, an electric motor, or a reversible machine which can operate in both modes.

The stator is fitted in a housing which is configured to rotate the shaft on bearings by means of roller bearings. The rotor comprises a body formed by a stack of metal plate sheets which are retained in the form of a set by means of an appropriate securing system. The rotor comprises poles formed by permanent magnets accommodated in cavities provided in the magnetic mass of the rotor.

In addition, the stator comprises a body constituted by a stack of thin metal plates forming a crown, the inner face of which is provided with notches which are open towards the interior in order to receive phase windings. These windings pass through the notches and form chignons which project on both sides of the stator body. The phase windings are obtained for example from a continuous wire covered with enamel, or from conductive elements in the form of pins which are connected to one another by welding. These windings are polyphase windings which are connected in the form of a star or a triangle, the outputs of which are connected to an inverter which can also operate as a rectifier bridge.

The objective of the invention is to optimise the configuration of an electrical machine of this type by reducing the torque undulations as well as the magnetic noise.

For this purpose, the subject of the invention is a rotary electrical machine for a motor vehicle, comprising:
a rotor;
a stator which extends along an axis, the said stator comprising a body provided with a plurality of stator teeth delimiting notches;
the stator comprising a winding comprising conductors which are accommodated in the notches;
on a plane orthogonal to the axis along which the stator extends:
a first notch has a first width measured in an orthoradial direction, and radially in the middle of the first notch;
a second notch, distinct from the first notch, has a second width measured in an orthoradial direction, and radially in the middle of the second notch,
   characterised in that the first notch width is different from the second notch width.

Thanks to the implementation of notches with different widths, the invention thus makes it possible to reduce efficiently the magnetic noise, as well as the torque undulations of the rotary electrical machine.

According to one embodiment, the said rotary electrical machine has a configuration of 1, or 1.5 or 2 notches per pole and per phase.

According to one embodiment, the number of conductors per notch is an even number.

According to one embodiment, all the conductors have a cross-section with the same surface area.

According to one embodiment, all the conductors have a cross-section with the same form.

According to one embodiment, a ratio between the first notch width divided by the second notch width is contained between 1.10 and 1.35.

According to one embodiment, the ratio between the first notch width divided by the second notch width is contained between 1.15 and 1.25.

According to one embodiment, the notches have parallel edges.

According to one embodiment, the stator teeth have parallel edges.

According to one embodiment, the stator has an alternation of first notches and second notches around its circumference.

According to one embodiment, the stator has an alternation of a first assembly of first notches and a second assembly of second notches around its circumference.

According to one embodiment, the first and the second assembly of notches each comprise between two and nine notches, the two assemblies of notches having the same number of notches.

According to one embodiment, each stator tooth comprises a tooth root, the tooth roots all having the same circumferential length, the said circumferential length being measured around an inner periphery of the stator body.

According to one embodiment, the first notch comprises a notch insulator with a thickness different from that of the notch insulator of the second notch.

According to one embodiment, the conductors are constituted by continuous wires or pins which are connected electrically to one another.

According to one embodiment, the stator is a laminated stator which is in a single piece or segmented.

According to one embodiment, the winding is of the star or triangle type.

According to another aspect, the subject of the invention is a rotary electrical machine for a motor vehicle comprising:
a rotor;
a stator comprising a body provided with a plurality of stator teeth delimiting notches;
the stator comprising a winding comprising conductors which are accommodated in each notch;
on a plane orthogonal to the axis along which the stator extends:
a first notch has a first width measured in an orthoradial direction, and radially in the middle of the first notch;
a second notch, distinct from the first notch, has a second width measured in an orthoradial direction, and radially in the middle of the second notch,
   characterised in that the first notch comprises a notch insulator with a thickness different from that of the notch insulator of the second notch.

The invention will be better understood by reading the following description and examining the figures which accompany it. These figures are provided purely by way of illustration, and in no way limit the invention.

FIG. 1 is a view in longitudinal cross-section of a rotary electrical machine according to the present invention;

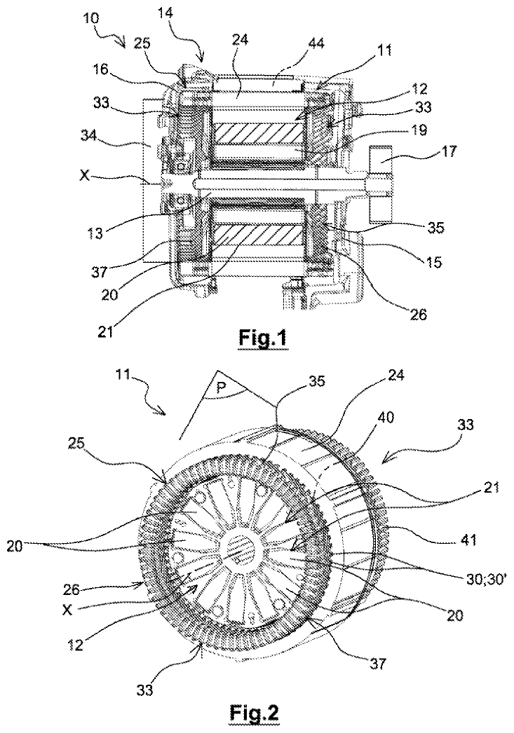

FIG. 2 is a view in perspective of the wound stator and of the rotor of the rotary electrical machine according to the present invention;

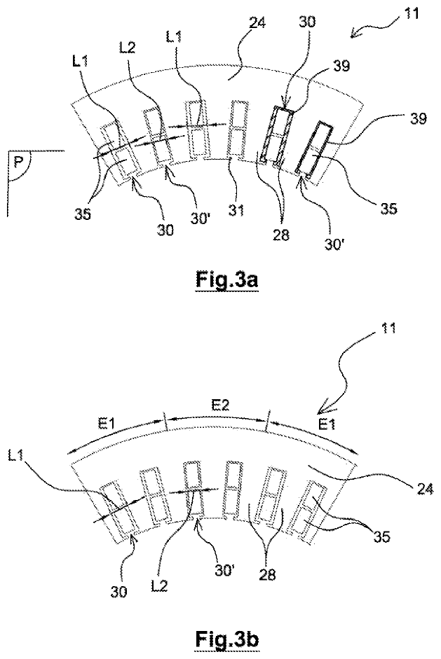

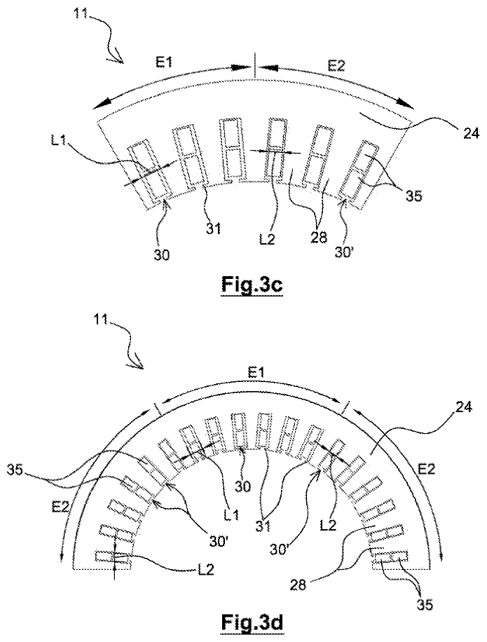

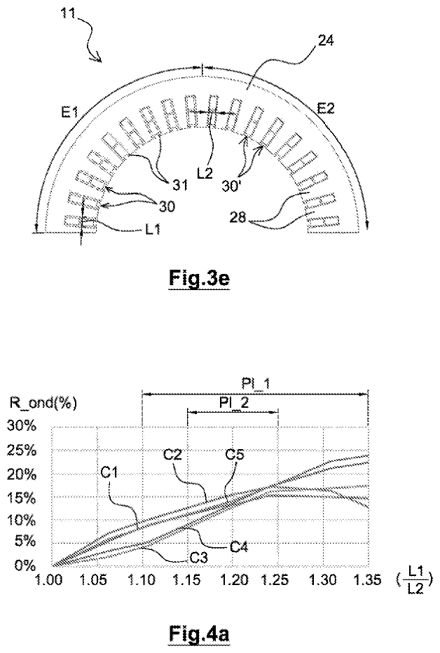

FIGS. 3a to 3e are views in partial transverse cross-section of the stator according to the present invention illustrating different patterns of notches with a variable width;

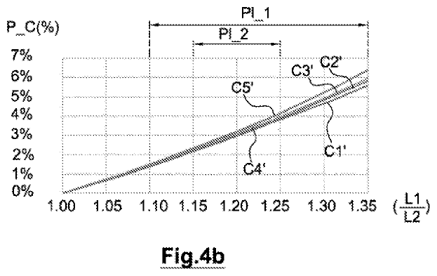

FIGS. 4a and 4b show graphic representations respectively of the development of the reduction of the torque undulation and of the development of the mean loss of torque according to the ratio between a first notch width and a second notch width.

Elements which are identical, similar or analogous retain the same reference from one figure to another.

FIG. 1 shows a rotary electrical machine 10 comprising a polyphase stator 11 surrounding a rotor 12 fitted on a shaft 13. The stator 11 surrounds the rotor 12 with the presence of an air gap between the inner periphery of the stator 11 and the outer periphery of the rotor 12. The stator 11 is fitted in a housing 14 provided with a front bearing 15 and a rear bearing 16 which support the shaft 13 with rotation.

This electrical machine 10 can in particular be designed to be coupled, via a pinion 17, to an element of a traction chain of a motor vehicle, such as a gearbox. The machine 10 can operate in an alternator mode, in order in particular to supply energy to the battery and to the on-board network of the vehicle, and in a motor mode, not only to ensure the starting of the thermal engine of the vehicle, but also to participate in the traction of the vehicle, alone or in combination with the thermal engine. As a variant, the electrical machine 10 can be implanted on a motor vehicle axle, in particular a rear axle. As a variant, the electrical machine 10 is in the form of an electric motor, or a non-reversible generator. The power of the electrical machine 10 is advantageously contained between 8 kW and 30 kW.

More specifically, as can be seen in FIG. 2, the rotor 12 comprises a body 19 in the form of a set of metal plates. Permanent magnets 20 can be implanted radially in the interior of the set of metal plates, with the lateral faces opposite one another of two consecutive magnets 20 having the same polarity. The rotor 12 is thus of the type with concentration of flux. As a variant, the permanent magnets 20 can be implanted in the interior of cavities 21, according to a configuration in the form of a “V”. Alternatively, the permanent magnets 20 extend orthoradially in the interior of the cavity 21 in the body 19. The magnets 20 can be made of rare earth or ferrite, according to the applications and the power required from the machine 10.

In addition, the stator 11 extends along an axis X corresponding to the axis of the shaft 13. The stator 11 comprises a body 24 constituted by a set of metal plates, as well as a winding 25. The body 24 is formed by a stack of metal plate sheets which are independent from one another, and are retained in the form of a set by means of an appropriate securing system. The stator body 24 can be of the type in a single piece or segmented, i.e. it can be made from a plurality of sections which each define an angular portion of the body, and are connected mechanically to one another.

The body 24 is provided with stator teeth 28, which delimit notches 30, 30′ in pairs for the fitting of the stator winding 25. Thus, two successive notches are separated from one another by a tooth 28.

In the example represented, the notches 30, 30′ have parallel edges. However, the invention is also applicable with stator teeth 28 with parallel edges, i.e. with notches 30, 30′ with a trapezoidal cross-section.

In addition, each tooth 28 comprises a tooth root 31 which is shown in FIGS. 3a to 3e. The tooth roots 31 all have the same circumferential length, which is measured around an inner periphery of the stator body 24.

The winding 25 comprises an assembly of phase windings 26 passing through the notches 30 and forming chignons 33 which extend projecting from both sides of the stator body 24. The outputs of the phase windings 26 are connected to an inverter 34, which can also operate as a rectifier bridge. For this purpose, the inverter 34 comprises power modules provided with power switching elements, such as transistors of the MOS type, connected to the phase outputs of the winding 25.

The winding 25 is formed from a plurality of conductors 35 constituted by pins 37. These pins 37 can have the form of a “U”, the ends of the branches of which are connected to one another by welding. As a variant, the winding 25 is formed from continuous conductive wires wound in the interior of the stator 11 in the notches 30, 30′, in order to form one or a plurality of turns.

The phase windings 26 are each associated with a series of notches 30, 30′. Advantageously, the stator 11 comprises a single one, or two independent three-phase systems, each formed by three phase windings 26. Each three-phase system can be coupled in the form of a triangle or a star.

More specifically, two consecutive notches 30, 30′ of the series are separated by adjacent notches corresponding to the other phases. Thus, when there are K phases, the conductors 35 of a single phase winding 26 are all inserted every K+1 notches. For example, if the winding of the first phase is inserted in notch no. 1, it is then inserted in the 4^{th} notch for a simple three-phase machine, with one notch per pole and per phase, i.e. K=3. It is also possible to provide a configuration with two notches per pole and per phase. It should be noted that a single notch 30, 30′ can receive conductors 35 belonging to two different phase windings in a preferential configuration of 1.5 notches per pole and per phase.

The number of conductors 35 in the interior of each notch 30, 30′ is advantageously even. In FIGS. 3a to 3e, each notch 30, 30′ contains 2 conductors. As a variant, the stator 11 can comprise 4 or 6 conductors per notch 30, 30′.

Preferably, in the interior of the notches 30, 30′, all the conductors 35 have a cross-section with the same surface area. In addition, all the conductors have a cross-section with the same form, such as a form which is square, rectangular, flattened, or round. The conductors 35 are stacked radially relative to one another in the interior of a notch 30, 30′.

In addition, as can be seen in FIG. 3a, along a plane P which is orthogonal to the axis on which the stator 11 extends, at least one first notch 30 has a first width L1, and at least one second notch 30′, which is distinct from the first notch 30, has a second width L2.

The widths L1, L2 are measured in a direction which is orthoradial relative to the axis X, and radially in the middle of the corresponding notch 30, 30′. The first notch width L1 is different from the second notch width L2. In this case, the notch width L1 is larger than the notch width L2.

In other words, the area of the transverse cross-section of the first notch 30 is different from the area of the transverse cross-section of the second notch 30′. Consequently, for conductors 35 which all have transverse cross-sections with the same surface area, the level of filling of the first notch 30 is different from that of the second notch 30′.

In addition, the first notch 30 comprises a notch insulator 39, in order to insulate the conductors 35 electrically relative to the stator body 24, which has a thickness which is different from, and in this case greater than, that of the notch insulator 39 of the second notch 30′. Only two notch insulators 39 have been represented in FIG. 3a in order to facilitate its legibility, but it is clear that an notch insulator 39 is positioned in the interior of each notch 30, 30′, between the conductor 35 and the inner faces of the corresponding notch 30, 30′.

In the example represented in FIG. 3a, the stator 11 has an alternation of first notches 30 and second notches 30′ around its circumference, i.e. around the circumference of the stator 11, there are found a first notch 30 with a first width L1, then immediately after a second notch 30′ with a second width L2, then immediately after a first notch 30 with a first width L1, then immediately after a second notch 30′ with a second width L2, and so on.

Alternatively, as represented in FIGS. 3b to 3e, around its circumference the stator 11 has an alternation of a first assembly E1 of first notches 30 which are adjacent to one another, and a second assembly E2 of second notches 30′ which are adjacent to another. Thus, around the circumference of the stator 11, there are found in succession a first assembly E1 of notches 30, and immediately after this first assembly E1 of notches 30, a second assembly E2 of notches 30′, and immediately after this second assembly E2 of notches 30′, a first assembly E1 of notches 30, then a second assembly E2, and so on around the circumference of the stator 11.

The first and second assemblies of notches E1, E2 each comprise between 2 and 9 notches 30, 30′. The two assemblies of notches E1, E2 have the same number of notches 30, 30′. In the embodiment in FIG. 3b, the first assembly E1 and the second assembly E2 of notches 30, 30′ each comprise two notches. In the embodiment in FIG. 3c, the first assembly E1 and the second assembly E2 of notches 30, 30′ comprise three notches 30 each. In the embodiment in FIG. 3d, the first assembly E1 and the second assembly E2 of notches 30, 30′ comprise six notches each. In the embodiment in FIG. 3e, the first assembly E1 and the second assembly E2 of notches 30, 30′ comprise nine notches each.

FIG. 4a illustrates the development of the reduction of undulation of the torque R_ond according to a ratio between the first notch width L1 and the second notch width L2 for an alternation of a single first notch 30 and second notch 30′ (cf. curve C1), as well as for an alternation of a first and a second assembly of notches E1, E2 each comprising respectively two notches (cf. curve C2), three notches (cf. curve C3), six notches (cf. curve C4), and nine notches (cf. curve C5).

FIG. 4b illustrates the development of the loss of mean torque P_C according to a ratio between the first notch width L1 and the second notch width L2 for an alternation of a single first notch 30 and second notch 30′ (cf. curve C1′), as well as for an alternation of a first and second assembly of notches E1, E2 each comprising respectively two notches (cf. curve C2′), three notches (cf. curve C3′), six notches (cf. curve C4′), and nine notches (cf. curve C5′).

The curves in FIGS. 4a and 4b have been obtained for a synchronous machine with permanent magnets comprising three phases and four pairs of poles. The electrical machine 10 also has a configuration of 1.5 notches per pole and per phase. However, the invention is not limited to a machine with four pairs of poles, but can be implemented with a machine comprising any polarity. The number of phases can also be adapted according to the application.

Advantageously, a range of values P1_1 is selected in which the ratio between the first notch width L1 divided by the second notch width L2 is contained between 1.10 and 1.35. According to an optimum configuration, this ratio L1/L2 is contained in the range P1_2 which extends between 1.15 and 1.25.

For all of the patterns of notches 30, 30′, a range of this type leads to a good compromise between the decrease in the torque undulation and the decrease in the mean torque. In fact, a range of values of this type makes it possible to obtain a substantial reduction of undulation of the torque which can reach almost 20%, whilst generating a maximum mean torque loss of less than 5%.

For a ratio of L1/L2 which exceeds 1.30, it is found that the reduction of the torque undulation begins to be toned down.

In addition, the electrical machine 10 can comprise a cooling liquid circuit comprising an input and an output for cooling liquid, in order to make the liquid circulate in a chamber 44 provided on the outer periphery of the stator 11, as shown in FIG. 2. The electrical machine 10 can thus be cooled by water or by oil.

It will be appreciated that the foregoing description has been provided purely by way of example, and does not limit the field of the invention, a departure from which would not be constituted by replacing the different elements by any other equivalents.

In addition, the different characteristics, variants, and/or embodiments of the present invention can be associated with one another according to different combinations, provided that they are not incompatible or mutually exclusive

1. The rotary electrical machine for a motor vehicle, comprising:
a rotor;
a stator which extends along an axis, the said stator comprising a body provided with a plurality of stator teeth delimiting notches;
the stator comprising a winding comprising conductors which are accommodated in the notches;
on a plane orthogonal to the axis along which the stator extends:
a first notch has a first width measured in an orthoradial direction, and radially in the middle of the first notch;
a second notch, distinct from the first notch, has a second width measured in an orthoradial direction, and radially in the middle of the second notch,
wherein the first notch width is different from the second notch width.

2. The rotary electrical machine according to claim 1, wherein the rotary electrical machine has a configuration of 1, or 1.5 or 2 notches per pole and per phase.

3. The rotary electrical machine according to claim 1, wherein the number of conductors per notch is an even number.

4. The rotary electrical machine according to claim 1, wherein all the conductors have a cross-section with the same surface area.

5. The rootary electrical machine according to claim 1, wherein all the conductors have a cross-section with the same form.

6. The rotary electrical machine according to claim 1, wherein a ratio between the first notch width divided by the second notch width is contained between 1.10 and 1.35.

7. The rotary electrical machine according to claim 6, wherein the ratio between the first notch width divided by the second notch width is contained between 1.15 and 1.25.

8. The rotary electrical machine according to claim 1, wherein the notches have parallel edges.

9. The rotary electrical machine according to claim 1, wherein the stator teeth have parallel edges.

10. The rotary electrical machine according to claim 1, wherein the stator has alternation of first notches and second notches around its circumference.

11. The rotary electrical machine according to claim 1, wherein the stator has an alternation of a first assembly of first notches and a second assembly of second notches around its circumference.

12. The rotary electrical machine according to claim 11, wherein the first and the second assembly of notches each comprise between two and nine notches, the two assemblies of notches having the same number of notches.

13. The rotary electrical machine according to claim 1, wherein each stator tooth comprises a tooth root, the tooth roots all having the same circumferential length, the said circumferential length being measured around an inner periphery of the stator body.

14. The rotary electrical machine according to claim 1, wherein the first notch comprises a notch insulator with a thickness different from that of the notch insulator of the second notch.

15. The rotary electrical machine according to claim 1, wherein the conductors are constituted by continuous wires or pins which are connected electrically to one another.
